(19) United States
(12) Patent Application Publication
(10) Pub. No.: US 2024/0372262 A1
(43) Pub. Date: Nov. 7, 2024

(54) Low-frequency band Dipole Unit, Multi-frequency band Array Antenna and Adjustment Method Therefor

(71) Applicant: BEIJING INSTITUTE OF SPACECRAFT SYSTEM ENGINEERING, Beijing (CN)

(72) Inventors: Bing MA, Beijing (CN); Fan LU, Beijing (CN); Wenjun GAO, Beijing (CN); Jiangnian DUAN, Beijing (CN); Yunzhong HAN, Beijing (CN); Zhijia LIU, Beijing (CN); Xiaotian WANG, Beijing (CN); Hua JIANG, Beijing (CN); Hongbin LI, Beijing (CN)

(21) Appl. No.: 18/657,794

(22) Filed: May 8, 2024

Related U.S. Application Data
(63) Continuation of application No. PCT/CN2021/133909, filed on Nov. 29, 2021.

(30) Foreign Application Priority Data
Nov. 9, 2021 (CN) 202111322197.7

(51) Int. Cl. H01Q 9/06; H01Q 21/26

(52) U.S. Cl. CPC H01Q 9/065; H01Q 21/26

(57) ABSTRACT

Disclosed are a low-frequency band dipole unit, a multi-frequency band array antenna and an adjustment method therefor. The low-frequency band dipole unit includes a first microstrip dipole arm (1), a second microstrip dipole arm (2) and a support structure (3). The first microstrip dipole arm (1) and the second microstrip dipole arm (2) are each in a T-shaped thin arm structure with two vertical arms upwards, each have a thickness in the order of millimeters, and are each in a straight line when viewed from above. The support structure (3) has a slot structure for clamping and supporting the first microstrip dipole arm (1) and the second microstrip dipole arm (2). The multi-frequency band array antenna has a plurality of columns and/or quasi-columns therein, and at least one column or quasi-column of the plurality of columns and/or quasi-columns is composed of the foregoing low-frequency band dipole units completely. The low-frequency band dipole unit has weak coupling and low blocking characteristics, is flexibly nested, and has a great arrangement freedom. The multi-frequency band array antenna has good arrangement freedom and beam adjustment freedom.

### TECHNICAL FIELD

The present application relates to the technical field of antennas, in particular to a low-frequency band dipole unit, a multi-frequency band array antenna and an adjustment method therefor.

### BACKGROUND

In recent years, with the rapid development of science and technology, the requirements for a mobile communication system such as 5G are increasingly high. On the one hand, the performance of the communication system is required to be better and better, and an antenna, serving as a key component of the communication system, is particularly required to satisfy multi-frequency band applications without interference between bands, and flexible adjustment of beams at the same time. On the other hand, the communication system is required to be smaller in volume, and lighter in size, and to be co-sited with multiple systems. A multi-system co-antenna design needs to be performed corresponding to the antenna, and the antenna needs to have a windward area as small as possible and a weight as light as possible. Therefore, the need for a multi-frequency band array antenna appears to be particularly urgent, and the core is to develop low-frequency band dipole unit adapted to a multi-frequency nested array and to study array arrangement techniques.

The multi-frequency band common-aperture array antenna is an antenna with a compact structure, which tends to enhance coupling between antennas, exacerbate blocking of a high-frequency band dipole unit by a low-frequency band dipole unit, thereby affecting the radiation performance of each band array. To this end, on the one hand, it is required to develop and improve the structure and form of a low-frequency band unit to reduce the possibility of coupling and blocking, and increase isolation of unit ports. On the other hand, it is required to develop or improve nesting and arrangement manner of array units to reduce the possibility of coupling and blocking from an arrangement perspective and increase isolation between units. A multi-frequency band array antenna is diverse in forms. For example, the invention patent “Antenna Control System and Multi-Frequency Common Antenna” (patent no.: CN201280065830.1) applied by Sun Shanqiu et al., in Comba Telecom Systems Holdings Limited includes a high-frequency band radiation array and a low band radiation array, wherein the low-frequency band radiation array includes radiation units that are coaxial and are laterally staggered along two axes. Some units in the high-frequency band radiation array are arranged coaxially along the same axis, and are nested with units that coincide with the positions of the low-frequency band units. Units that are adjacent to each other have the equal feed-in power, and units that are distant from each other also have the same feed-in power. An ideal pattern may be obtained. The invention patent “Antenna Array Element, Array Antenna, Multi-frequency Antenna Unit and Multi-frequency Array Antenna” (patent number: CN201210591056. X) applied by Luo Yingtao et al., in Huawei Technologies Co., Ltd., proposes an array unit including two antenna unit pairs in a cross arrangement. Two antenna units in each antenna element pair are electrically connected to each other through a feeding network while being separately fed, respectively. The unit performance of a single antenna can be improved, and a multi-frequency antenna array formed by arrays occupies less space at the same time.

The present multi-frequency array antenna has the main limitation of shortage of the degree of freedom, which specifically includes two aspects: first, gaps between high-frequency band units and low-frequency band units need to satisfy integral multiple due to the limitation of the gaps when the high-frequency band units and the low-frequency band units are nested; second, the flexibility for adjustment of beams on the horizontal plane is not enough, which is adjusted by beam widths of dipole units, the size of a bottom plate, and heights of isolating bars, and the adjustment range is limited. The low-frequency band dipole units often take a bowl-shaped form to nest with the high-frequency band dipole units, which affects the flexibility of the arrangement of the high-frequency band units and the low-frequency band units, and the gaps between the high-frequency band units and the low-frequency band units needs to satisfy an integer multiple relationship. Instead, low-frequency band dipole units that do not take a bowl-shaped form have greater influences on the high-frequency band dipole units.

### SUMMARY

In order to solve the above technical problems, the present application provides a low-frequency band dipole unit and a multi-frequency array antenna, which solve the technical problems in the prior art of the limitation in gaps when high-frequency band dipole units and low-frequency band dipole units of the multi-frequency array antenna are nested, and not enough flexibility of adjustment on beams in a horizontal plane.

According to a first aspect of the present application, a low-frequency band dipole unit is provided, including: a first microstrip dipole arm, a second microstrip dipole arm and a support structure.

The first microstrip dipole arm and the second microstrip dipole arm are in a criss-cross perpendicular arrangement.

The first microstrip dipole arm is in a T-shaped thin arm structure with two upward vertical arms, has a thickness in the order of millimeters, and is in a straight line when viewed from above. A front face of the first microstrip dipole arm is engraved with a first microstrip line in a form of a microstrip or in a manner of a dielectric plate clad with copper, and is used for feeding a low-frequency band dipole unit in +45° polarization. A back face of the first microstrip dipole arm is engraved with a metal ground in a form of a microstrip or in a manner of a dielectric plate clad with copper.

The second microstrip dipole arm is in a T-shaped thin arm structure with two upward vertical arms, has a thickness in the order of millimeters, and is in a straight line when viewed from above. A front face of the second microstrip dipole arm is engraved with a first microstrip line in a form of a microstrip or in a manner of a dielectric plate clad with copper, and is used for feeding a low-frequency band dipole unit in −45° polarization. A back face of the second microstrip dipole arm is engraved with a metal ground in a form of a microstrip or in a manner of a dielectric plate clad with copper.

The support structure has a slot structure for clamping and supporting the first microstrip dipole arm and the second microstrip dipole arm.

According to the above solution of the present application, the low-frequency band dipole unit provided by the present application may greatly reduce the coupling and blocking with other units by greatly optimizing a radiating patch area and designing a radiation arm to be bent upward with respect to bowl-shaped low-frequency band dipole units or other conventional low-frequency band dipole units. The low-frequency band dipole unit has weak coupling and low blocking characteristics, can be flexibly nested, and has a greater arrangement freedom.

According to a second aspect of the present application, a low-frequency band dipole unit is provided, including: a first microstrip dipole arm, a second microstrip dipole arm, and a support structure.

The first microstrip dipole arm and the second microstrip dipole arm are in a criss-cross perpendicular arrangement.

The first microstrip dipole arm is in a T-shaped thin arm structure with two upward vertical arms, has a thickness in the order of millimeters, and is in a straight line when viewed from above.

The second microstrip dipole arm is in a T-shaped thin arm structure with two upward vertical arms, has a thickness in the order of millimeters, and is in a straight line when viewed from above.

The first microstrip dipole arm and the second microstrip arm are each in a form of double faces clad with copper wherein one face is clad with copper entirely, and the other face is etched with a microstrip line. The faces, clad with copper entirely, of the first microstrip dipole arm and the second microstrip dipole arm have identical copper cladding regions. The microstrip line of the first microstrip dipole arm is different from the microstrip line of the second microstrip dipole arm.

The support structure has a slot structure for clamping and supporting the first microstrip dipole arm and the second microstrip dipole arm.

According to the above solution of the present application, the low-frequency band dipole unit provided by the present application may greatly reduce the coupling and blocking with other units by greatly optimizing a radiating patch area and designing a radiation arm to be bent upward with respect to bowl-shaped low-frequency band dipole units or other conventional low-frequency band dipole units. The low-frequency band dipole unit has weak coupling and low blocking characteristics, can be flexibly nested, and has a greater arrangement freedom.

Preferably, the microstrip line of the first microstrip dipole arm has a first-stage bent segment upwards starting from a first feeding port, which is denoted as a first bent segment. The microstrip line of the second microstrip dipole arm has a first-stage bent segment upwards starting from a second feeding port, which is denoted as a second bent segment. A length of the first bent segment is less than that of the second bent segment, and a difference in the lengths of the first bent segment and the second bent segment is less than a width of the microstrip line.

According to the above solution of the present application, the two bent segments are set to have unequal lengths, and the length difference less than the width of the microstrip line in order to achieve the purposes that first, the microstrip lines do not interfere each other when the two microstrip dipole arms are in cross arrangement, and second, the electrical properties of the two microstrip dipole arms do not differ significantly, so that the feeding ports of the two microstrip dipole arms are well matched electrically.

Preferably, a microstrip plate of the first microstrip dipole arm is provided with a slot upwards, and the slot is centered transversely, and has a length less than a difference between a height of the microstrip plate and the length of the first bent segment of the first microstrip dipole arm. A microstrip plate of the second microstrip dipole arm is provided with a slot downwards, and the slot is centered transversely, and has a length less than the length of the second bent segment of the second microstrip dipole arm.

According to the above solution of the present application, the first microstrip dipole arm and the second microstrip dipole arm may be closely plugged together while the microstrip lines do not interfere with each other.

Preferably, the low-frequency band dipole unit has two feeding ports. The first microstrip dipole arm corresponds to the first feeding port, and the second microstrip dipole arm corresponds to the second feeding port. Each feeding port corresponds to a polarization form.

According to the above solution of the present application, it is possible to have two ±45° polarizations for the low-frequency band dipole unit, and meanwhile, the electrical properties of the two polarizations are comparable.

Preferably, the support structure is an integrated structure on which a slot structure is provided for clamping and supporting the dipole arms.

According to the above solution of the present application, the dipole arms may be effectively supported and clamped.

Preferably, the support structure includes two parts: a horizontal support and a vertical support. An annular structure is employed for support in a horizontal direction, and a cylindrical structure is employed for support in a vertical direction at a cross-shaped central part formed by the crossing of the two dipole arms. The cylindrical structure and the annular structure are connected to each other by a reinforcing bar, wherein the reinforcing bar is capable of clamping and supporting a horizontally disposed parts of the dipole arms.

According to the above solution of the present application, it is possible to form a unit structure having higher rigidity and better resistance to mechanical environment.

Preferably, the first microstrip dipole arm and the second microstrip dipole arm are each in a face structure, and each have a thickness between 0.254˜3.048 mm.

The above solution of the present application ensures proper electrical properties, small size, light weight, and weak coupling with the high-frequency band dipole unit and no or less blocking to the high-frequency band dipole unit.

According to a third aspect of the present application, a multi-frequency band array antenna is provided, including a plurality of band array units. The multi-frequency band array antenna has a plurality of columns and/or quasi-columns therein, wherein at least one column or quasi-column of the plurality of columns and/or quasi-columns is composed of low-frequency band dipole units completely, and the column or quasi-column composed of low-frequency band dipole units completely is parallel to an axis at which other-frequency band array units are located. At least one of the low-frequency band dipole units is located on the axis at which the other-frequency band array units are located.

According to the above solution of the present application, a beam width in a horizontal plane may be flexibly adjusted by an array arrangement manner of arranging one low-frequency band dipole unit separately on one side of the array, and the dipole unit can be nested in other-frequency band arrays, so that the flexibility of adjusting the beam width in the horizontal plane is greatly improved without an increase in an additional arrangement area.

According to the above solution of the present application, the low-frequency band dipole unit, when nested with the other-frequency band arrays, may be flexibly nested and has a greater arrangement freedom due to its weak coupling and low blocking characteristics. The multi-column nesting arrangement provided by the present application provides, on the one hand, a reasonable use of the arrangement space and an increased isolation between adjacent dipole units in the same band, and, on the other hand, a greater freedom of arrangement and beam adjustment, in particular beam width adjustment and beam shape adjustment.

According to a fourth aspect of the present application, an adjustment method for the multi-frequency band array antenna as described above is provided, including: determining to-be-adjusted dipole units in the multi-frequency band array antenna, wherein one or more of the to-be-adjusted dipole units are provided;
acquiring radiation patterns of the to-be-adjusted dipole units each in the multi-frequency band array antenna;
feeding the radiation patterns back to the multi-frequency band array antenna based on the radiation patterns, and performing amplitude-phase optimization on to-be-adjusted dipole units corresponding to the radiation patterns; and
adjusting an amplitude and phase for feeding of the multi-frequency band array antenna based on amplitude-phase optimization results of the to-be-adjusted dipole units.

### Advantageous Effects

(1) The low-frequency band dipole unit of the present application adopts a T-shaped thin arm cross structure, and has a greatly reduced possibility of coupling and blocking with other units since radiation arms are designed to be in an upward bending form and are in cross arrangement. With respect to bowl-shaped low-frequency band dipole units or other conventional low-frequency band dipole units, the low-frequency band dipole unit of the present application has weak coupling and low blocking characteristics, can be flexibly nested, and has a greater arrangement freedom.
(2) In a preferred embodiment, the bent structure is designed such that two bent segments have unequal lengths, and the length difference less than the width of the microstrip line in order to achieve the purposes that first, the microstrip lines do not interfere each other when the two microstrip dipole arms are in cross arrangement, and second, the electrical properties of the two microstrip dipole arms do not differ significantly, so that the feeding ports of the two microstrip dipole arms are well matched electrically.
(3) In a preferred embodiment, the sizes of slots in the microstrip plates of the two microstrip dipole arms are designed, such that the first microstrip dipole arm and the second microstrip dipole arm may be closely plugged together while the microstrip lines do not interfere with each other.
(4) In a preferred embodiment, each of the first microstrip dipole arm and the second microstrip dipole arm is provided with a feeding port, such that it is possible to have two ±45° polarizations for the low-frequency band dipole unit, and meanwhile, the electrical properties of the two polarizations are comparable.
(5) The support structure adopts an integrated annular+cylinder structure so as to have higher rigidity and better resistance to mechanical environment.
(6) The first microstrip dipole arm and the second microstrip dipole arm each have a thickness between 0.254˜3.048 mm, thereby ensuring proper electrical properties, small size, light weight, and weak coupling with the high-frequency band dipole unit and no or less blocking to the high-frequency band dipole unit.
(7) When the multi-frequency band array antenna is formed by using the low-frequency band dipole unit provided in the present application, the low-frequency band dipole unit, when nested with the other-frequency band arrays, may be flexibly nested and has a greater arrangement freedom due to its weak coupling and low blocking characteristics. The multi-column nesting arrangement provided by the present application provides, on the one hand, a reasonable use of the arrangement space and an increased isolation between adjacent dipole units in the same band, and, on the other hand, a greater freedom of arrangement and beam adjustment, in particular beam width adjustment and beam shape adjustment.
(8) The adjustment method for the multi-frequency band array antenna provided by the present application, first, calculates the radiation patterns of the units in the actual array, performs amplitude-phase optimization with respect to the actual radiation patterns, and finally synthetically optimizes the amplitude and phase for feeding of the array. With respect to a conventional equi-amplitude same-phase form or ideal Chebyshev weighting form, the present application may further eliminate the impacts of blocking and mutual coupling of the arrays based on the elimination of most of the blocking and mutual coupling by the low-frequency band dipole unit of the aforementioned application, resulting in an ideal antenna radiation pattern.

The above description is only an overview of the technical solutions of the present application. In order to understand the technical means of the present application more clearly and implement the technical means according to the contents of the description, the following detailed description is given with reference to the preferred embodiments of the present application in conjunction with the drawings.

### BRIEF DESCRIPTION OF FIGURES

The drawings, which form a part of the present application, are used to further understand the present application, and the present application is described below with reference to the drawings. In the drawings:

FIG. 1(A) is a section view of a low-frequency band dipole unit in a first angle according to a first embodiment of the present application;

FIG. 1(B) is a partially enlarged view of an intersection of a first microstrip dipole arm and a second microstrip dipole arm, which is labeled as I, in the section view of the low-frequency band dipole unit in the first angle according to the first embodiment of the present application;

FIG. 2(A) is a section view of a low-frequency band dipole unit in a second angle according to a first embodiment of the present application;

FIG. 2(B) is a partially enlarged view of a lower middle position of a low-frequency band dipole unit in a second angle according to a first embodiment of the present application;

FIG. 3 is a graph of a gain pattern of a low-frequency band dipole unit of the present application;

FIG. 4 is a schematic diagram of a multi-frequency band array antenna according to a second embodiment of the present application;

FIG. 5 is a schematic diagram of a multi-frequency band array antenna according to a third embodiment of the present application;

FIG. 6 is a schematic diagram of a multi-frequency band array antenna according to a fourth embodiment of the present application;

FIG. 7 is a graph of a low-frequency band normalized gain pattern of the present application; and

FIG. 8 is a graph of a high-frequency band normalized gain pattern of the present application.

Reference numerals: I, partially enlarged view of an intersection of a first microstrip dipole arm and a second microstrip dipole arm; II, a partially enlarged view of a lower middle position of a low-frequency band dipole unit in a second angle according to a first embodiment; 1, first microstrip dipole arm; 2, second microstrip dipole arm; 3, support structure; 11, first microstrip line; 12, first copper cladding layer; 13, first microstrip plate front face; 14, first bent segment; 15, first feeding port; 21, second microstrip line; 22, second copper cladding layer; 23, second microstrip plate front face; 24, second bent segment; 25, second feeding port.

### DETAILED DESCRIPTION

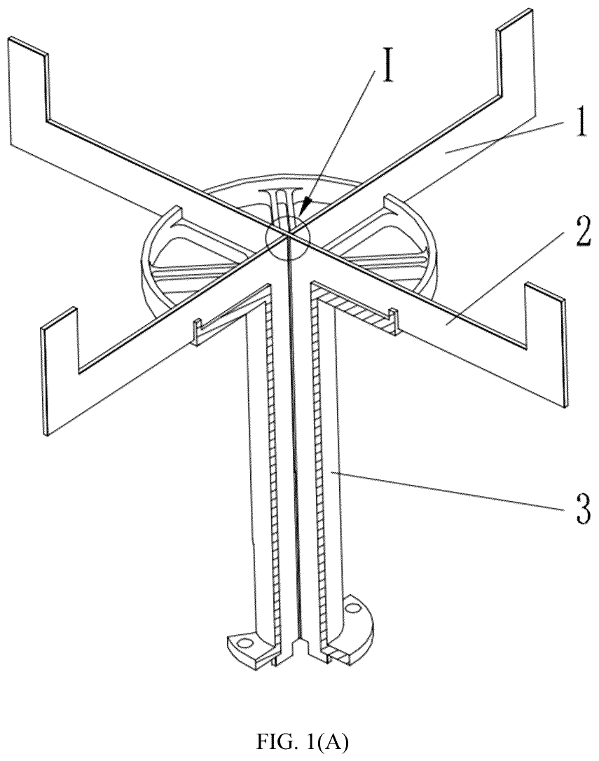

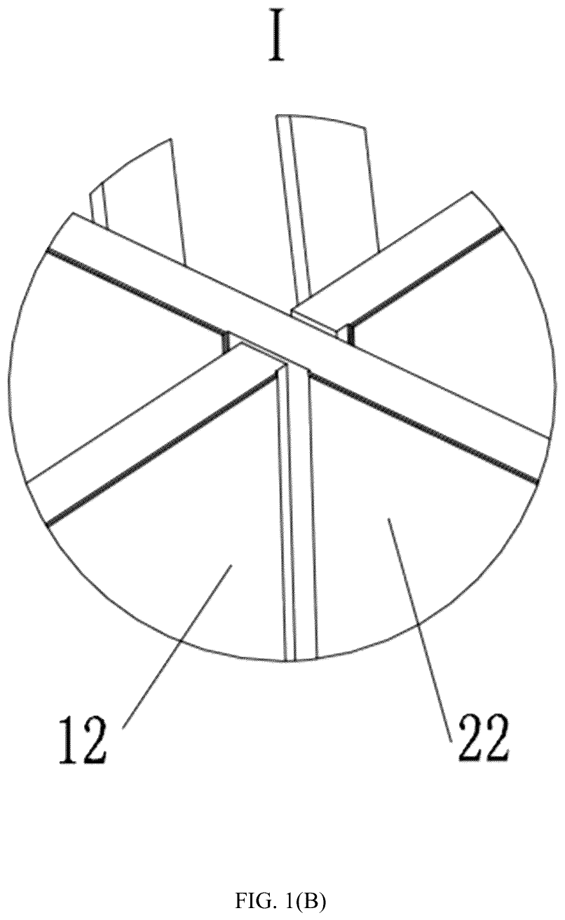

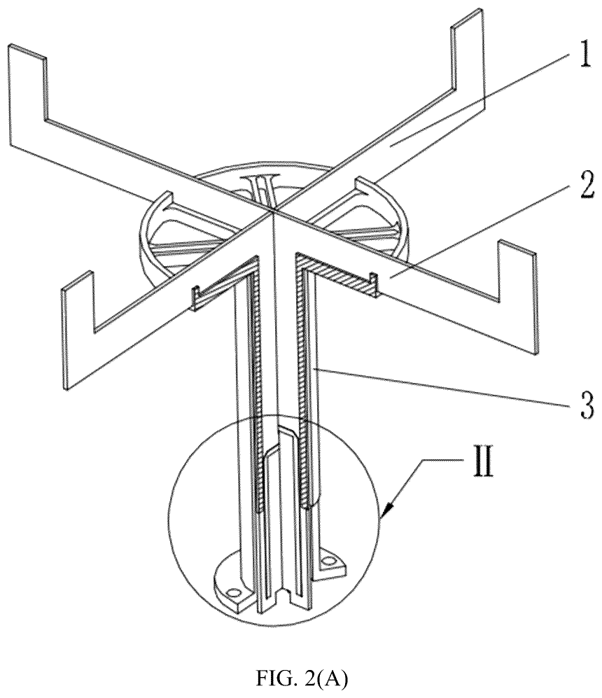

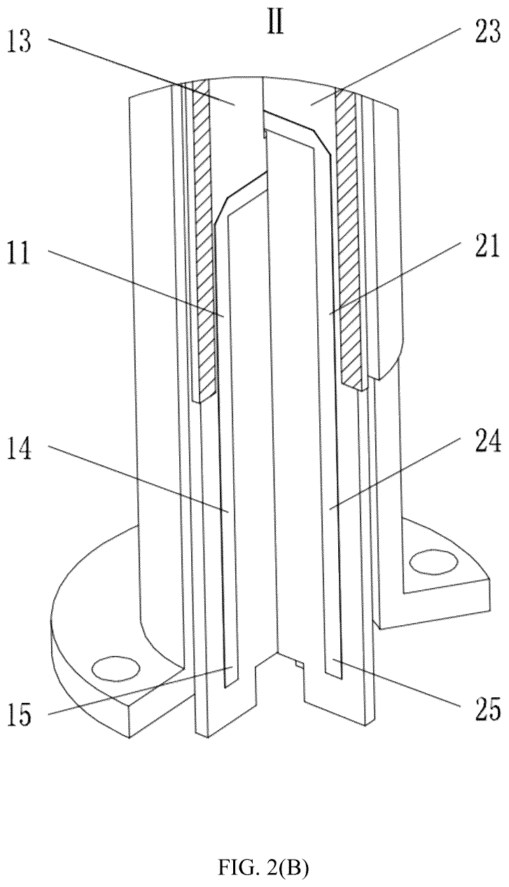

First, a low-frequency band dipole unit according to an embodiment of the present application will be described in combination with FIGS. 1(A)-1(B) and FIGS. 2(A)-2(B). The low-frequency band dipole unit includes: a first microstrip dipole arm 1, a second microstrip dipole arm 2 and a support structure 3.

The first microstrip dipole arm 1 and the second microstrip dipole arm 2 are in a criss-cross perpendicular arrangement.

The first microstrip dipole arm 1 is in a T-shaped thin arm structure with two upward vertical arms, has a thickness in the order of millimeters, and is in a straight line when viewed from above. A front face of the first microstrip dipole arm 1 is engraved with a microstrip line in a form of a microstrip or in a manner of a dielectric plate clad with copper, and is used for feeding a low-frequency band dipole unit in +45° polarization. A back face of the first microstrip dipole arm 1 is engraved with a metal ground in a form of a microstrip or in a manner of a dielectric plate clad with copper.

The second microstrip dipole arm 2 is in a T-shaped thin arm structure with two upward vertical arms, has a thickness in the order of millimeters, and is in a straight line when viewed from above. A front face of the second microstrip dipole arm 2 is engraved with a microstrip line in a form of a microstrip or in a manner of a dielectric plate clad with copper, and is used for feeding a low-frequency band dipole unit in −45° polarization. A back face of the second microstrip dipole arm is engraved with a metal ground in a form of a microstrip or in a manner of a dielectric plate clad with copper.

The support structure 3 has a slot structure for clamping and supporting the first microstrip dipole arm 1 and the second microstrip dipole arm 2.

In this embodiment, as shown in FIGS. 1(A)-1(B), a first copper cladding layer 12 is provided on the back face of the first microstrip dipole arm 1, and a second copper cladding layer 22 is provided on the back face of the second microstrip dipole arm 2. The first microstrip dipole arm 1 and the second microstrip dipole arm 2 are in face structures, each have a thickness between 0.254˜3.048 mm, and are each in a straight line when viewed from above, which reduces the possibility of blocking and coupling with a high-frequency band dipole unit in a vertical direction. Transverse lengths of the dipole arms may be greatly shortened due to the upward vertical arms, reducing the possibility of blocking and coupling with other-frequency band dipole units in a transverse direction. The low-frequency band dipole unit in this embodiment ensures proper electrical properties, small size, light weight, and weak coupling with the high-frequency band dipole unit and no or less blocking the high-frequency band dipole unit. In this embodiment, the front face of the first microstrip arm 1 may be opposite to the front face of the second microstrip arm 2 or the back face of the second microstrip arm 2. Similarly, the back face of the first microstrip dipole arm 1 may be opposite to the front face of the second microstrip dipole arm 2, or may be also opposite to the back face of the second microstrip dipole arm 2. The situations that the front face of the first microstrip dipole arm 1 is opposite to the back face of the second microstrip dipole arm 2, the front face of the first microstrip dipole arm 1 is opposite to the front face of the second microstrip dipole arm 2, the back face of the first microstrip dipole arm 1 is opposite to the front face of the second microstrip dipole arm 2, and the back face of the first microstrip dipole arm 1 is opposite to the back face of the second microstrip dipole arm 2 are present at four regions formed by the criss-cross arrangement due to the first microstrip dipole arm 1 and the second microstrip dipole arm 2 in a criss-cross perpendicular arrangement.

In another embodiment, the first microstrip dipole arm 1 and the second microstrip dipole arm 2 are each in a form of double faces clad with copper, wherein one face is clad with copper entirely, and the other face is etched with a microstrip line. The faces, clad with copper entirely, of the first microstrip dipole arm 1 and the second microstrip dipole arm 2 have identical copper cladding regions. The microstrip line of the first microstrip dipole arm 1 is different from the microstrip line of the second microstrip dipole arm 2. A first microstrip 11, a first copper cladding layer 12, a second microstrip 21, a second copper cladding layer 22 are as shown in FIG. 1(B) and FIG. 2(B). In this embodiment, the front face of the first microstrip arm 1 may be opposite to the front face of the second microstrip arm 2 or the back face of the second microstrip arm 2. Similarly, the back face of the first microstrip dipole arm 1 may be opposite to the front face of the second microstrip dipole arm 2, or may be also opposite to the back face of the second microstrip dipole arm 2. The situations that the front face of the first microstrip dipole arm 1 is opposite to the back face of the second microstrip dipole arm 2, the front face of the first microstrip dipole arm 1 is opposite to the front face of the second microstrip dipole arm 2, the back face of the first microstrip dipole arm 1 is opposite to the front face of the second microstrip dipole arm 2, and the back face of the first microstrip dipole arm 1 is opposite to the back face of the second microstrip dipole arm 2 are present at four regions formed by the criss-cross arrangement due to the first microstrip dipole arm 1 and the second microstrip dipole arm 2 in a criss-cross perpendicular arrangement.

Further, the microstrip line of the first microstrip dipole arm 1 has a first-stage bent segment upwards starting from a first feeding port, which is denoted as a first bent segment. The microstrip line of the second microstrip dipole arm 2 has a first-stage bent segment upwards starting from a second feeding port, which is denoted as a second bent segment. A length of the first bent segment is less than that of the second bent segment, and a difference in the lengths of the first bent segment and the second bent segment is less than a width of the microstrip line. The two bent segments are set to have unequal lengths, and the length difference less than the width of the microstrip line in order to achieve the purposes that first, the microstrip lines do not interfere each other when the two microstrip dipole arms are in cross arrangement, and second, the electrical properties of the two microstrip dipole arms do not differ significantly, so that the feeding ports of the two microstrip dipole arms are well matched electrically.

Further, a microstrip plate of the first microstrip dipole arm 1 is provided with a slot upwards, and the slot is centered transversely, and has a length slightly less than a difference between a height of the microstrip plate and the length of the first bent segment of the first microstrip dipole arm 1. A microstrip plate of the second microstrip dipole arm 2 is provided with a slot downwards, and the slot is centered transversely, and has a length slightly less than the length of the second bent segment of the second microstrip dipole arm 2. The first microstrip dipole arm 1 and the second microstrip dipole arm 2 are connected in a plugging manner.

Further, the low-frequency band dipole unit has two feeding ports which are formed in the first microstrip dipole arm 1 and the second microstrip dipole arm 2 separately, and each feeding port corresponds to a polarization form. In this embodiment, the feeding ports may be directly soldered with a high-frequency band cable, or may be soldered with a coaxial socket and then connected with the high-frequency band cable.

In this embodiment, the support structure 3 is an integrated structure on which a slot structure is provided for clamping and supporting the dipole arms, such that the dipole arms having greater sizes and lower stiffness are integrated with the support structure to form a unified structure having higher stiffness. The support structure includes two parts: a horizontal support and a vertical support. An annular structure is employed for support in a horizontal direction since the dipole arms have greater sizes in the horizontal direction. A cylindrical structure is employed for support in a vertical direction, which mainly refers to support at a cross-shaped central part formed by the crossing of the two dipole arms. The cylindrical structure and the annular structure are connected to each other by a reinforcing bar, and meanwhile the reinforcing bar may clamp and support a horizontally disposed parts of the dipole arms. An outer diameter and a wall thickness of the annular structure may be determined according to the overall stiffness requirements of the units. In general, the outer diameter of the annular structure is selected to be more than ½ of the length of the dipole arm, and is increased as the structural size of the outermost side of the dipole arm in the vertical increases. If necessary, for example, in the case that the dipole arm is excessively long when a corresponding operating frequency is less than 600 MHz, a multi-layer annular structure may be provided to connect the dipole arms in sections to form a unit structure having higher stiffness and better resistance to mechanical environment.

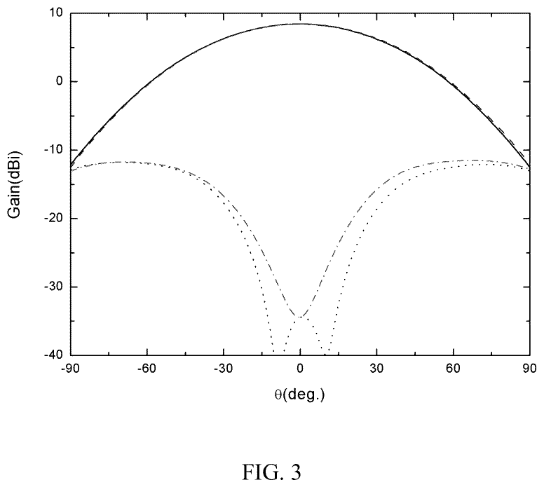

FIG. 3 shows a graph of a gain pattern of the low-frequency band dipole unit of the present application, with a total of four curves corresponding to principle polarization gain patterns in a horizontal plane, a principle polarization gain pattern in a vertical plane, a cross polarization gain pattern in the horizontal plane, and a cross polarization gain pattern in the vertical plane of the low-frequency band dipole unit. It can be seen that in the low band, the antenna gain is not less than 8 dBi and the cross polarization is more than-30 dB, demonstrating good electrical property of the low-frequency band dipole unit applied.

A multi-frequency band array antenna according to an embodiment of the present application will be described below. The multi-frequency band array antenna includes a plurality of band array units, wherein a low-frequency band array unit is the low-frequency band dipole unit as described above. The multi-frequency band array antenna has a plurality of columns and/or quasi-columns therein, wherein at least one column or quasi-column of the plurality of columns and/or quasi-columns is composed of low-frequency band dipole units completely, and the column or quasi-column composed of low-frequency band dipole units completely is parallel to an axis at which other-frequency band array units are located. At least one of the low-frequency band dipole units is located on the axis at which the other-frequency band array units are located. The quasi-columns are staggered columns, i.e., unit centers lie on two or more straight lines.

Arrays of the multi-frequency band array antenna are located on a metal reflector plate in a column arrangement or quasi-column arrangement. The columns or quasi-columns other than a low-frequency band column of the multi-frequency band array antenna are formed in such a manner that multi-frequency band dipole units are in one column; or multi-frequency band dipole units are cross-nested in one column; or one-frequency band dipole unit is cross-nested distributed in multiple columns.

The arrays of the multi-frequency band array antenna according to the present application aim to provide a multi-frequency band array antenna, which ensures no influence or less influence between the bands, reasonable electrical properties, small size and light weight, and satisfies communication applications.

Further, the multi-frequency band array antenna feeds the dipole units through a feeding network, the dipole units in individual bands may have different feeding power according to the arrangement manner of the multi-frequency band array antenna, and the feeding power is comprehensively optimized according to the arrangement power of the multi-frequency band array antenna and the pattern requirements of the multi-frequency band array antenna.

Further, low-frequency band radiation units of the multi-frequency band array antenna are the low-frequency band dipole units as described above. Each dipole unit includes a pair of orthogonally disposed dual-polarization low-frequency band dipoles that may be fed with equal or unequal power in two polarizations.

Further, a high-frequency band array or other-frequency band array of the multi-frequency band array antenna is a dual-polarization dipole unit in a conventional form, and two dipole arms of a pair of dipoles of the dipole unit are disposed orthogonally, and the power fed to the dual-polarization dipole unit in two polarizations may be equal or unequal.

Further, low-frequency band radiation arrays of the multi-frequency band array antenna are arranged along at least two axes parallel to each other, and adjacent dipole units have equal axial intervals. High-frequency band radiation arrays or other-frequency band arrays are arranged along at least one axis, and adjacent dipole units have equal axial intervals.

Further, the interval between the dipole units on the axis of the low-frequency band radiation array of the multi-frequency band array antenna is half of the center wavelength in the low band, and the interval between the dipole units on the axis of the high-frequency band radiation array or other-frequency band array is half of the center wavelength in the corresponding band, wherein the interval is optimized for specific pattern requirements on an initial basis.

Further, in addition to avoiding physical interference, the interval between the dipole units of any one-frequency band array is not affected by the interval between the dipole units of the other-frequency band array, i.e., there is no necessary relationship between the interval between the dipole units, greatly increasing the arrangement freedom.

Further, the low-frequency band radiation array has at least one column of dipole units nested within the high-frequency band array or other-frequency band array, and has an axis coincident with the axis of the high-frequency band array or other-frequency-band array. The power fed to the nested dipole unit in this column may be or may not be equal to the power fed to the dipole units in other columns.

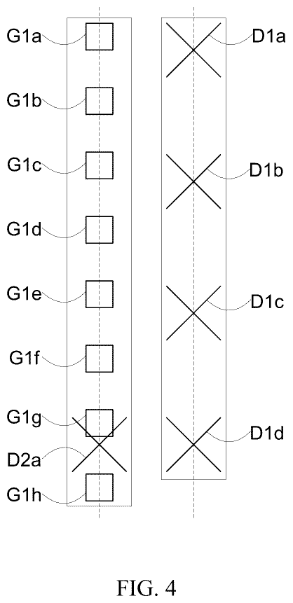

FIG. 4 shows an embodiment of a multi-frequency band array antenna of the present application. Two columns of low-frequency band arrays D1 and D2 and one column of high-frequency band array G1 are arranged on a reflector plate. The low-frequency band array D2 has only one antenna unit D2a that is nested in the high-frequency band array G1, and D2 and G1 are arranged coaxially. The low-frequency band array D1 is composed of four array elements D1a, D1b, D1c and D1d uniformly distributed, wherein an interval between the array elements is typically taken as 0.5˜0.8 times a center operating wavelength. An amplitude and phase of the low-frequency band array D1 is determined by weighting, and uses different weighting manners depending on the specific pattern requirements. The low-frequency band array D2 is composed of only one array element D2a, which is vertically aligned with the array element D1d. The amplitude and phase of D2a is determined by the pattern requirements in a horizontal plane. A radiation pattern in the array is usually first calculated and then substituted into the array for comprehensive optimization. The four array elements D1a, D1b, D1c and D1d in the array D1 and the one array element D2a in the array D2 are fed by the same set of feeding network. The high-frequency band array G1 is composed of eight array elements G1a, G1b, G1c, G1d, G1e, G1f, G1g and G1h distributed at equal intervals, wherein an axis of the high-frequency band array G1 is parallel to an axis of the low-frequency band array D1. The amplitude and phase of the high-frequency band array G1 and the amplitude and phase of the low-frequency band array D2 are calculated by the same method, wherein a radiation pattern in the array is usually first calculated and then substituted into the array for comprehensive optimization. The eight array elements of the high-frequency band array G1 are fed by the same set of feeding network. The arrangement flexibility is greatly increased by using the low-frequency band dipole unit of the present application, and the low-frequency band dipole unit may be flexibly nested in the high-frequency band array G1, wherein the location can be synthetically optimized.

That is, in this embodiment, the low-frequency band radiation array includes 2 columns of low-frequency band dipole units arranged along two parallel axes, wherein one column includes a plurality of low-frequency band dipole units distributed uniformly, this column of dipole units may be fed using an equi-amplitude same-phase form, may also be fed using low-sidelobe weighting forms such as a Chebyshev weighting form, or may be fed using a beamforming form or other amplitude-optimized forms. The other column includes only one low-frequency band dipole unit which is identical to the other low-frequency band dipole units, is nested in the high-frequency band array or other-frequency band arrays, is located on the axis, and is flush with a unit at one end the first column of the low-frequency band array. The low-frequency band dipole unit and the first column of low-frequency band dipole units are fed using the same set of feeding network, but the amplitude and phase for feeding are separately designed, and are determined depending on the array arrangement and pattern requirements in the horizontal plane.

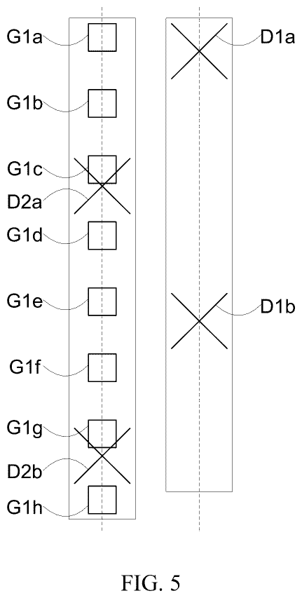

FIG. 5 shows another embodiment of a multi-frequency band array antenna of the present application. Two columns of low-frequency band arrays D1 and D2 and one column of high-frequency band array G1 are arranged on a reflector plate. The low-frequency band array D2 is in crossed arrangement with the low-frequency band array D1, and is nested in the high-frequency band array G1, wherein D2 and G1 are arranged coaxially. The low-frequency band array D1 is composed of two array elements D1a and D1b distributed uniformly, and the low-frequency band array D2 is composed of two array elements D2a and D2b distributed uniformly. The longitudinal interval between D1 and D2 is considered comprehensively, wherein the longitudinal interval between D1a and D2a is generally 0.5˜0.8 times the center operating wavelength, and the longitudinal intervals between D2a and D1b and between D1b and D2b are also equal. The amplitudes and phases of the low-frequency band arrays D1 and D2 are overall designed comprehensively, are determined by weighting, and use different weighting manners depending on the specific pattern requirements. A radiation pattern in the array is usually first calculated and then substituted into the array for comprehensive optimization. The two array elements D1a and D1b in the array D1 and the two array elements D2a and D2b are fed by the same set of feeding network as the two elements in the D2 array. The array D2 is nested within the array G1, and the interval between the arrays is not limited by the interval of the array G1. The high-frequency band array G1 is composed of eight array elements G1a, G1b, G1c, G1d, G1e, G1f, G1g and G1h distributed at equal intervals, wherein an axis of the high-frequency band array G1 is parallel to an axis of the low-frequency band array D1. The amplitude and phase of the high-frequency band array G1 and the amplitude and phase of the low-frequency band array D2 are calculated by the same method, wherein a radiation pattern in the array is usually first calculated and then substituted into the array for comprehensive optimization. The eight array elements of the high-frequency band array G1 are fed by the same set of feeding network. The arrangement flexibility is greatly increased by using the low-frequency band dipole unit and the comprehensive optimization algorithm of the present application, and the low-frequency band dipole unit may be flexibly nested in the high-frequency band array G1, wherein the location may be comprehensively optimized.

That is, in this embodiment, the low-frequency band radiation array includes two columns of low-frequency band dipole units arranged along two parallel axes, and the two columns of dipole units are in staggered arrangement, wherein one column is arranged separately, and includes a plurality of low-frequency band dipole units; the other column is nested with the high-frequency band array or other-frequency band array, includes a plurality of low-frequency band dipole units distributed uniformly, and has an axis that coincides with an axis of the high-frequency band array or the other-frequency band array. The two columns of low-frequency band dipole units are distributed uniformly along an axis direction, and the interval between the units is not necessarily related to the interval between the units in the high-frequency band array or other-frequency band array, leading to a greater arrangement freedom. The two columns of low-frequency band dipole units are entirely fed by one set of feeding network, and the amplitudes and phases for feeding of the arrays in the two columns is designed comprehensively. The arrays are initially fed using an equi-amplitude same-phase form, may also be fed using a low-sidelobe weighting form, or may be fed using a beamforming form or other amplitude-optimized form, all of which ultimately take into account the array arrangement for comprehensive amplitude-phase optimization.

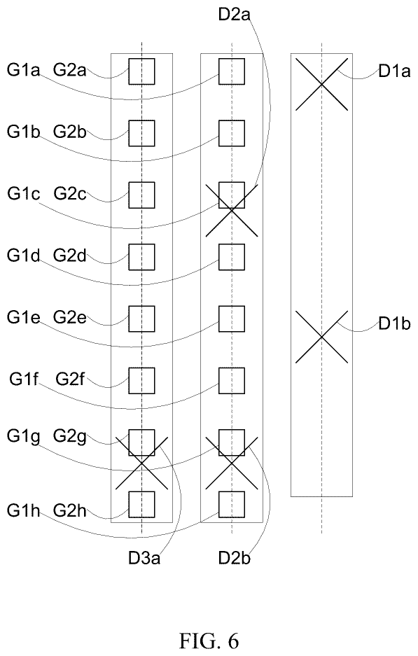

FIG. 6 shows yet another embodiment of a multi-frequency band array antenna of the present application. Three columns of low-frequency band arrays D1, D2 and D3, and two columns of high-frequency band arrays G1 and G2 are arranged on a reflector plate. The low-frequency band array D2 is in crossed arrangement with the low-frequency band array D1, and is nested in the high-frequency band array G1, wherein D2 and G1 are arranged coaxially. The low-frequency band array D3 is composed of only one array element D3a which is nested in the high-frequency band array G2, wherein D3 and G2 are arranged coaxially. The axes of the three low frequency arrays D1, D2 and D3 are parallel to each other. The low-frequency band array D1 is composed of two array elements D1a and D1b distributed uniformly, and the low-frequency band array D2 is composed of two array elements D2a and D2b distributed uniformly. The longitudinal interval between D1 and D2 is considered comprehensively, wherein The longitudinal interval between D1a and D2a is generally 0.5˜0.8 times the center operating wavelength, and the longitudinal intervals between D2a and D1b and between D1b and D2b are also equal. The amplitudes and phases of the low-frequency band arrays D1 and D2 are overall designed comprehensively, are determined by weighting, and use different weighting manners depending on the specific pattern requirements. A radiation pattern in the array is usually first calculated and then substituted into the array for comprehensive optimization. The amplitude and phase of the array element D3a in the low-frequency band array D3 are determined by pattern requirements in the horizontal plane. A radiation pattern in the array is usually first calculated and then substituted into the array for comprehensive optimization. The low-frequency band arrays D1, D2 and D3 are fed by the same set of feeding network. The array D2 is nested in the array G1, and the array D3 is nested in the array G2. However, the interval between the arrays is not limited by the interval between the array G1 and the array G2. The high-frequency band array G1 is composed of eight array elements G1a, G1b, G1c, G1d, G1e, G1f, G1g and G1h distributed at equal intervals. The high-frequency band array G2 is composed of eight array elements G2a, G2b, G2c, G2d, G2e, G2f, G2g and G2h distributed at equal intervals. The axes of the array G1 and the array G2 are parallel to the axis of the low-frequency band array D1. The amplitudes and phases of the high-frequency band arrays G1 and G2 and the amplitudes and phases of the low-frequency band arrays D2 and D3 are calculated by the same method, wherein a radiation pattern in the array is usually first calculated and then substituted into the array for comprehensive optimization. The eight array elements in the high-frequency band array G1 are fed by the same set of feeding network, and the eight array elements of the high-frequency band array G2 are fed by another set of feeding network. The arrangement flexibility is greatly increased by using the low-frequency band dipole unit and the comprehensive optimization algorithm of the present application, and D2 and D3 may be flexibly nested in the high-frequency band arrays G1 and G2, wherein the locations may be comprehensively optimized.

That is, in this embodiment, a low-frequency band radiation array includes three columns of low-frequency band dipole units arranged along three parallel axes, wherein a first column of dipole units are arranged separately, a second column of dipole units are nested in high-frequency band dipole units or units in other-frequency band array and are in staggered arrangement with the first column of dipole units. A third column of dipole units are nested in another column of high-frequency band dipole units or units in other-frequency band array and are flush with a dipole unit at one end of an adjacent array. The axes of low-frequency band arrays in the second column and the third column coincide with the axes of the high-frequency band array or other-frequency band array. Three columns of low-frequency band arrays are entirely fed by one set of feeding network, wherein the amplitudes and phases for feeding of the array in the first column and the array in the second column are designed comprehensively. The arrays are initially fed using an equi-amplitude same-phase form is used initially, may also be fed using a low-sidelobe weighting form, or may be fed using a beamforming form or other amplitude-optimized form, all of which ultimately take into account the array arrangement for comprehensive amplitude-phase optimization. The amplitude and phase for feeding of the low-frequency band array in the third column are designed separately, are determined depending on the array arrangement and pattern requirements in the horizontal plane.

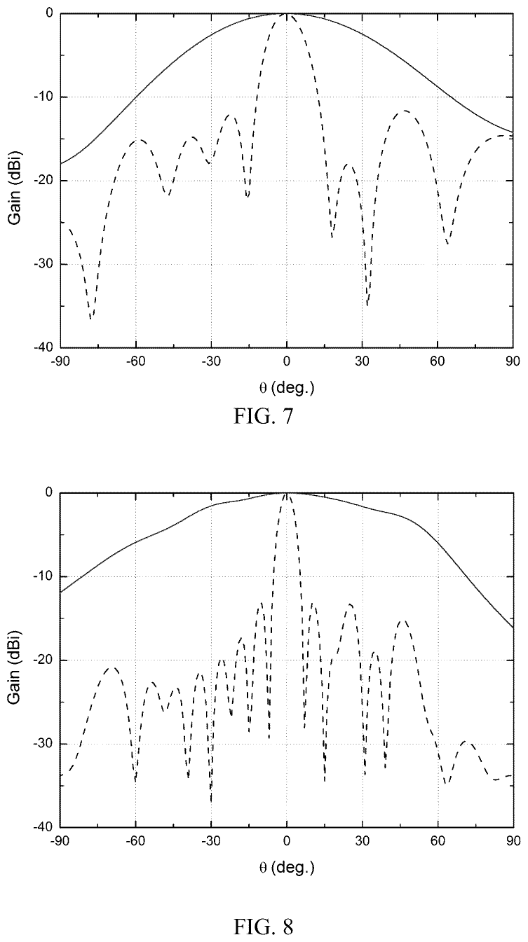

FIG. 7 shows a graph of a low-land normalized gain pattern according to an embodiment, including two main polarization curves in a horizontal plane and a vertical plane. It can be seen from the graph that the curves in the horizontal plane and the vertical plane present well, there is a great beam width on the horizontal plane, and significant beam adjustment may be performed by isolated low-frequency band units. There is a small beam width on the vertical plane, and different coverage forms may be designed by further optimizing amplitude-phase weighting. Two sectional patterns are hardly affected by high-frequency band arrays or other-frequency band arrays, demonstrating good performance of the provided multi-frequency band array antenna at a low frequency band.

FIG. 8 shows a graph of a high-frequency band normalized gain pattern, including two main polarization curves in a horizontal plane and a vertical plane. It can be seen from the graph that the curves in the horizontal plane and the vertical plane present well, there is a great beam width on the horizontal plane, and significant beam adjustment may be performed by isolated high-frequency band units. There is a small beam width on the vertical plane, and different coverage forms may be designed by further optimizing amplitude-phase weighting. Two sectional patterns are hardly affected by low-frequency band arrays or other-frequency band arrays, demonstrating good performance of the provided multi-frequency band array antenna at a high frequency band.

The embodiments of the low-frequency band dipole unit and the embodiments of the multi-frequency band array antenna described above represent only a few embodiments of the present application, which are described in detail, but are not to be construed as limiting the scope of the claims. It should be noted that, those of ordinary skill in the art may make several variations and modifications without departing from the concept of the present application, and these variations and modifications fall within the protection scope of the present application.

The low-frequency band dipole unit of the present application is composed of two microstrip dipole arms and one support structure only. The antenna structure is simple, and the microstrip dipole arm is in a form of a microstrip or a form of a dielectric plate clad with copper, has a shape in a form of a T-shaped structure with two upward vertical arms, or other variations based on this structure. By means of the upward vertical arms, the transverse length of the dipole arm can be greatly shortened and the possibility of blocking other-frequency dipole units may be reduced. By design optimization, the sectional areas of the dipole arms are substantially reduced, and further the possibility of blocking and coupling may be further reduced. On the other hand, the support structure in the present application has the advantages of high level of integration and unity, and the unique slot form achieves a smaller volume and a lighter weight while supporting the dipole arms suffering from a load environment.

The present application provides an array arrangement manner that one low-frequency band dipole unit is arranged separately on one side of the array, and this dipole unit can be nested in a high-frequency band array or other-frequency band array, so that the beam width on the horizontal plane may be flexibly adjusted, which greatly increases the flexibility of adjusting the beam width in the horizontal plane without an increase in an additional arrangement area.

The present application provides a multi-column nesting arrangement in which a low-frequency band array is cross-nested within a high-frequency band array or other-frequency band array, and the interval of the low frequency array is not affected by the interval of high-frequency band array or other-frequency band array. The desired electrical property of the antenna can be achieved in combination with amplitude-phase optimization manner for feeding as described above. On the one hand, the arrangement space may be reasonably used, and isolation between adjacent dipole units in the same frequency band may be increased. On the other hand, there is a greater freedom of arrangement and beam adjustment, in particular beam width adjustment and beam shape adjustment.

An adjustment method for a multi-frequency band array antenna as described above according to an embodiment of the present application is described below. The method includes: determining to-be-adjusted dipole units in the multi-frequency band array antenna, wherein one or more of the to-be-adjusted dipole units are provided; acquiring radiation patterns of the to-be-adjusted dipole units in the multi-frequency band array antenna; feeding the radiation patterns back to the multi-frequency band array antenna based on the radiation patterns, and performing amplitude-phase optimization on to-be-adjusted dipole units corresponding to the radiation patterns; and adjusting an amplitude and phase for feeding of the multi-frequency band array antenna based on amplitude-phase optimization results of the to-be-adjusted dipole units.

With respect to a conventional equi-amplitude same-phase form or ideal Chebyshev weighting form, the method first calculates the radiation patterns of the units in the actual array, performs amplitude-phase optimization with respect to the actual radiation patterns to synthetically optimize the amplitude and phase for feeding of the array, substitutes the optimized radiation patterns in the final actual array arrangement for optimization iterations, resulting in the desired radiation patterns finally.

It should be noted that the embodiments and the features of the embodiments in the present application can be combined with each other without conflict.

The above embodiments are only used to illustrate the technical solutions of the present application, rather than limiting the technical solutions. Although the present application has been described in detail with reference to the foregoing embodiments, it will be understood by those skilled in the art that modifications may be made to the technical solutions described in the foregoing embodiments or equivalent replacements may be made to some of the features thereof. Such modifications or replacements do not make the essence of the technical solution materially depart from the spirit and scope of the technical solutions of the embodiments of the present application.

1. A low-frequency band dipole unit, comprising: a first microstrip dipole arm (1), a second microstrip dipole arm (2) and a support structure (3); wherein
the first microstrip dipole arm (1) and the second microstrip dipole arm (2) are in a criss-cross perpendicular arrangement;
the first microstrip dipole arm (1) is in a T-shaped thin arm structure with two upward vertical arms, has a thickness in the order of millimeters, and is in a straight line when viewed from above; a front face (13) of the first microstrip dipole arm (1) is engraved with a first microstrip line (11) in a form of a microstrip or in a manner of a dielectric plate clad with copper, and is used for feeding a low-frequency band dipole unit in +45° polarization; a back face of the first microstrip dipole arm (1) is engraved with a metal ground in a form of a microstrip or in a manner of a dielectric plate clad with copper;
the second microstrip dipole arm (2) is in a T-shaped thin arm structure with two upward vertical arms, has a thickness in the order of millimeters, and is in a straight line when viewed from above; a front face (23) of the second microstrip dipole arm (2) is engraved with a second microstrip line (21) in a form of a microstrip or in a manner of a dielectric plate clad with copper, and is used for feeding a low-frequency band dipole unit in −45° polarization; a back face of the second microstrip dipole arm (2) is engraved with a metal ground in a form of a microstrip or in a manner of a dielectric plate clad with copper; and
the support structure (3) has a slot structure for clamping and supporting the first microstrip dipole arm (1) and the second microstrip dipole arm (2).

2. A low-frequency band dipole unit, comprising: a first microstrip dipole arm (1), a second microstrip dipole arm (2) and a support structure (3); wherein
the first microstrip dipole arm (1) and the second microstrip dipole arm (2) are in a criss-cross perpendicular arrangement;
the first microstrip dipole arm (1) is in a T-shaped thin arm structure with two upward vertical arms, has a thickness in the order of millimeters, and is in a straight line when viewed from above;
the second microstrip dipole arm (2) is in a T-shaped thin arm structure with two upward vertical arms, has a thickness in the order of millimeters, and is in a straight line when viewed from above;
the first microstrip dipole arm (1) and the second microstrip dipole arm (2) are each in a form of double faces clad with copper, wherein one face is clad with copper entirely, and the other face is etched with a microstrip line; the faces, clad with copper entirely, of the first microstrip dipole arm (1) and the second microstrip dipole arm (2) have identical copper cladding regions; the microstrip line of the first microstrip dipole arm (1) is different from the microstrip line of the second microstrip dipole arm (2); and
the support structure (3) has a slot structure for clamping and supporting the first microstrip dipole arm (1) and the second microstrip dipole arm (2).

3. The low-frequency band dipole unit according to claim 1, wherein the microstrip line of the first microstrip dipole arm (1) has a first-stage bent segment upwards starting from a first feeding port (15), which is denoted as a first bent segment (14); the microstrip line of the second microstrip dipole arm (2) has a first-stage bent segment upwards starting from a second feeding port (25), which is denoted as a second bent segment (24); and a length of the first bent segment is less than that of the second bent segment, and a difference in the lengths of the first bent segment and the second bent segment is less than a width of the microstrip line.

4. The low-frequency band dipole unit according to claim 3, wherein a microstrip plate of the first microstrip dipole arm (1) is provided with a slot upwards, and the slot is centered transversely, and has a length less than a difference between a height of the microstrip plate and the length of the first bent segment of the first microstrip dipole arm (1); a microstrip plate of the second microstrip dipole arm is provided with a slot downwards, and the slot is centered transversely, and has a length less than the length of the second bent segment of the second microstrip dipole arm (2).

5. The low-frequency band dipole unit according to claim 3, wherein the low-frequency band dipole unit has two feeding ports; the first microstrip dipole arm (1) corresponds to the first feeding port (15), and the second microstrip dipole arm (2) corresponds to the second feeding port (25); and each feeding port corresponds to a polarization form.

6. The low-frequency band dipole unit according to claim 1, wherein the support structure (3) is an integrated structure on which a slot structure is provided for clamping and supporting the dipole arms.

7. The low-frequency band dipole unit according to claim 6, wherein the support structure (3) comprises two parts: a horizontal support and a vertical support; an annular structure is employed for support in a horizontal direction, and a cylindrical structure is employed for support in a vertical direction at a cross-shaped central part formed by the crossing of the two dipole arms; and the cylindrical structure and the annular structure are connected to each other by a reinforcing bar, wherein the reinforcing bar is capable of clamping and supporting a horizontally disposed parts of the dipole arms.

8. The low-frequency band dipole unit according to claim 1, wherein the first microstrip dipole arm (1) and the second microstrip dipole arm (2) are each in a face structure, and each have a thickness between 0.254 and 3.048 mm.

9. A multi-frequency band array antenna, comprising multi-frequency band array units, wherein a low-frequency band array unit is the low-frequency band dipole unit according to claim 1, and wherein the multi-frequency band array antenna has a plurality of columns and/or quasi-columns therein, at least one column or quasi-column of the plurality of columns and/or quasi-columns is composed of low-frequency band dipole units completely, and the column or quasi-column composed of low-frequency band dipole units completely is parallel to an axis at which other-frequency band array units are located; and at least one of the low-frequency band dipole units is located on the axis at which the other-frequency band array units are located.

10. An adjustment method for the multi-frequency band array antenna according to claim 9, comprising:
determining to-be-adjusted dipole units in the multi-frequency band array antenna, wherein one or more of the to-be-adjusted dipole units are provided;
acquiring radiation patterns of the to-be-adjusted dipole units each in the multi-frequency band array antenna;
feeding the radiation patterns back to the multi-frequency band array antenna based on the radiation patterns, and performing amplitude-phase optimization on to-be-adjusted dipole units corresponding to the radiation patterns; and
adjusting an amplitude and phase for feeding of the multi-frequency band array antenna based on amplitude-phase optimization results of the to-be-adjusted dipole units.

11. The low-frequency band dipole unit according to claim 2, wherein the microstrip line of the first microstrip dipole arm (1) has a first-stage bent segment upwards starting from a first feeding port (15), which is denoted as a first bent segment (14); the microstrip line of the second microstrip dipole arm (2) has a first-stage bent segment upwards starting from a second feeding port (25), which is denoted as a second bent segment (24); and a length of the first bent segment is less than that of the second bent segment, and a difference in the lengths of the first bent segment and the second bent segment is less than a width of the microstrip line.

12. The low-frequency band dipole unit according to claim 11, wherein a microstrip plate of the first microstrip dipole arm (1) is provided with a slot upwards, and the slot is centered transversely, and has a length less than a difference between a height of the microstrip plate and the length of the first bent segment of the first microstrip dipole arm (1); a microstrip plate of the second microstrip dipole arm is provided with a slot downwards, and the slot is centered transversely, and has a length less than the length of the second bent segment of the second microstrip dipole arm (2).

13. The low-frequency band dipole unit according to claim 11, wherein the low-frequency band dipole unit has two feeding ports; the first microstrip dipole arm (1) corresponds to the first feeding port (15), and the second microstrip dipole arm (2) corresponds to the second feeding port (25); and each feeding port corresponds to a polarization form.

14. The low-frequency band dipole unit according to claim 2, wherein the support structure (3) is an integrated structure on which a slot structure is provided for clamping and supporting the dipole arms.

15. The low-frequency band dipole unit according to claim 14, wherein the support structure (3) comprises two parts: a horizontal support and a vertical support; an annular structure is employed for support in a horizontal direction, and a cylindrical structure is employed for support in a vertical direction at a cross-shaped central part formed by the crossing of the two dipole arms; and the cylindrical structure and the annular structure are connected to each other by a reinforcing bar, wherein the reinforcing bar is capable of clamping and supporting a horizontally disposed parts of the dipole arms.
